(19) United States
(12) Patent Application Publication
(10) Pub. No.: US 2004/0083397 A1
(43) Pub. Date: Apr. 29, 2004

(54) Method for making an electronic device having a power-non-savable processor power-savable and circuit thereof

(76) Inventor: Chien-Tsung Chen, Tu-Cheng City (TW)

Correspondence Address: SUPREME PATENT SERVICES, POST OFFICE BOX 2339, SARATOGA, CA, 95070, US

(21) Appl. No.: 10/324,349

(22) Filed: Dec. 18, 2002

(30) Foreign Application Priority Data
Oct. 24, 2002 (TW) 091124706

(51) Int. Cl. G06F 1/32

(52) U.S. Cl. 713/320

(57) ABSTRACT

A power-saving method for making an electronic device having a power-non-savable processor power-savable comprises several steps including: (a) A step for providing a power-switching element for power's on/off operation of a power-non-savable processor, in accordance with the clock of a power-saving device; (b) A step for turning power “off” in a cyclic time period of a first clock, or turning the power “on” in another time period of a second clock, generated by the power-saving device alternately; and (c) A step for determining the cyclic time period of both the first and the second clocks, such that an average current smaller than a predetermined current can be maintained.

### FIELD OF THE INVENTION

This invention relates generally to a power-saving circuit, particularly to make an electronic device, such as a keyboard, mouse, or other input device, having at least a power-non-savable processor, power-savable.

### BACKGROUND OF THE INVENTION

In the prior arts for saving power consumption of a processor or controller, there is usually the alternative of adopting a power-savable processor or controller, which is more expensive, or choosing a dual-frequency processor or controller, in which a high or a low frequency may be chosen according to preset conditions, and the cost entailed is the efforts paid for finding an optimum processor or controller applicable for dual-frequency operation.

For meeting the requirements of environmental protection, on the electrical rating table, the total current consumed in some USB RF electronic devices is allowed no more than 2.5 mA in “sleep” mode regulated under USB IF for instance. The production cost of a USB device can be hardly reduced by using the power-savable processor or controller directly, while the alternative should take the processor or controller made specifically under USB IF instead of an arbitrary cheaper dual-frequency power-non-savable processor or controller, so that the cost is integrally high either.

Therefore, in view of abovesaid defects, this inventor has endeavored for a long time to consequently propose this invention in the hope of contributing more or less to this field.

### SUMMARY OF THE INVENTION

The primary objective of this invention is to provide a power-saving method and circuit thereof. When the method and circuit is applied to a power-non-savable processor, the total current consumption under a power-saving mode can be lowered below a predetermined level.

Another objective of this invention is to provide a power-saving method and circuit thereof. When the method and circuit is applied to a power-non-savable processor, the total current consumption under a power-saving mode can be maintained in conformity with a predetermined level of the industrial standards.

In order to realize abovesaid objectives, a power-saving method of this invention comprises several steps including: (a) A step for providing a power-switching element for power's on/off operation of a power-non-savable processor, in accordance with the clock of a power-saving device; (b) A step for turning power “off” in a cyclic time period of a first clock, or turning the power “on” in another time period of a second clock, generated by the power-saving device alternately; and (c) A step for determining the cyclic time period of both the first and the second clocks, such that an average current smaller than a predetermined current can be maintained.

Moreover, a power-saving circuit of this invention for making an electronic device having at least a power-non-savable processor power-savable comprises: a power-switching element for keeping power's on/off operation of a power-non-savable processor, in accordance with the clock of a power-saving device, in which the power-saving device is in charge of releasing a cyclic signal of a first or a second clock for turning power supply of the power-non-savable processor off or on to therefore lower down the total average current of the first and the second clocks below a predetermined level.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 shows the flowchart of a power-saving method of this invention;

FIG. 2 shows the configuration of a power-saving circuit according to the method shown in FIG. 1;

FIG. 3 shows a concrete structure of the circuit shown in FIG. 2; and

FIG. 4 shows a command-flowchart of a specific power-savable microcontroller MC68HC908JB8.

### DETAILED DESCRIPTION OF THE INVENTION

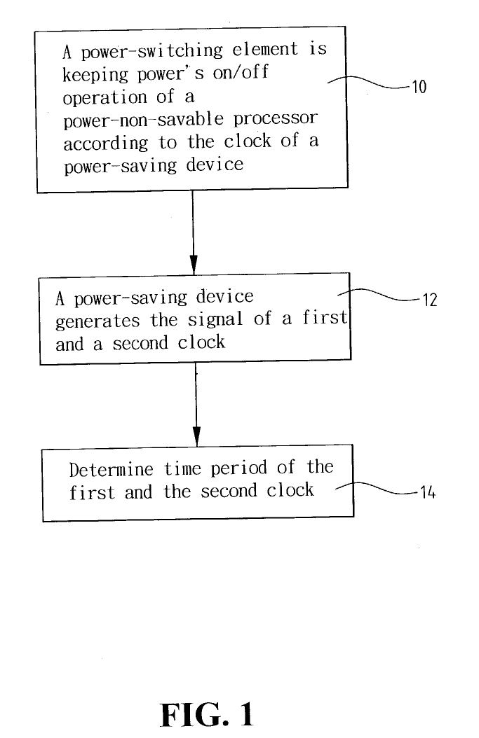

FIG. 1 shows the flowchart of a power-saving method of this invention. The method of this invention for saving power as illustrated in FIG. 1 is overtured for applying to particularly an electronic device having at least a power-non-savable processor, for example, to an input device including keyboard, mouse, etc., to hence make it power-savable.

The method of this invention for saving power is comprised at least of the following steps:

a step (10) for providing a power-switching element 26 for keeping power's on/off operation of a power-non-savable processor 24, in accordance with the clock 220 of a power-saving device 22;

a step (12) for turning power “off” in a cyclic time period of a first clock 22a, or turning the power “on” in another time period of a second clock 22b, generated by the power-saving device 22 alternately; and

a step (14) for determining the cyclic time period of both the first and the second clocks 22a/22b, such that an average current Iₐᵥₑ smaller than a predetermined current Iₜₒₜₐₗ can be obtained.

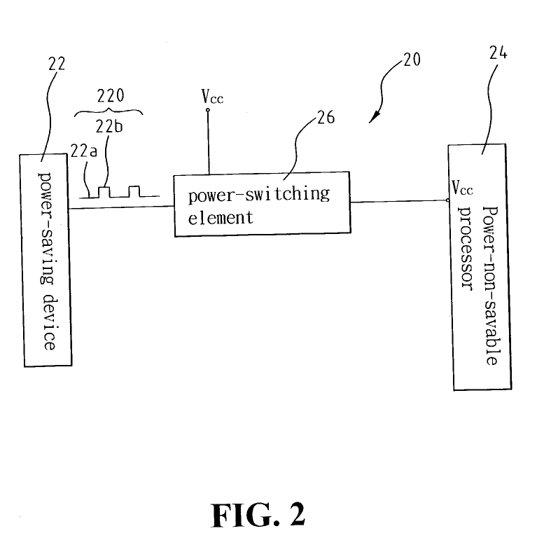

FIG. 2 shows the configuration of a power-saving circuit according to the method shown in FIG. 1. In FIG. 2, assuming the normal working-current of the power-non-savable processor 24, the power-saving device 22, and the power-saved current are I₁, I₂₀, and I₂₁, respectively, then a power-saving circuit 20 should satisfy the equation below:

((T₁*I₂₁)+(T₂*(I₁+I₂₀+I₃)))/(T₁+T₂)≦Iₜₒₜₐₗ

where T₁ and T₂ are time periods of the first and the second clock 22a/22b, respectively, and I₃ represents the total current consumption of all the other components.

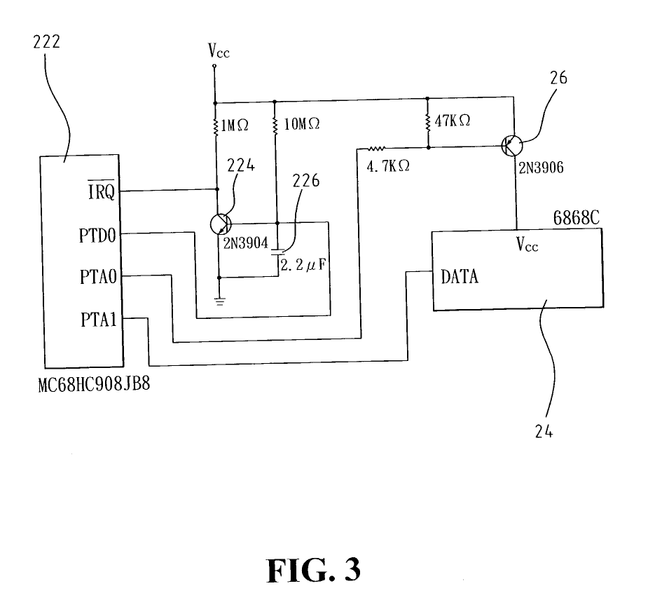

FIG. 3 shows a concrete structure of the circuit shown in FIG. 2. In FIG. 3, the power-non-savable processor 24 could be a keyboard controller 6868C of Novatek Company operated normally at a working current 20 mA (namely, I₁=20 mA), and the power-saving device 22 comprises at least a power-savable microcontroller 222, a transistor 224, and a capacitor 226, in which the microcontroller 222 could be the microcontroller MC68HC908JB8 of Motorola, operated normally at a working current 7.5 mA (namely, I₂₀=7.5 mA) while idled at a power-saving current 350 μA (namely, I₂₁=350 μA).

In the event of applying the concrete circuit shown in FIG. 3 to a wireless keyboard, I₃ would represent the total current consumption of all the other components, including that of a RF receiver (namely, I₃=10 mA). Thus, the total current consumption of the wireless keyboard under normal working conditions is the sum of I₂₀+I₃+I₁=7.5 mA+10 mA+20 mA=37.5 mA.

The total current consumption of the wireless keyboard operated in power-saving mode must be lower than a predetermined level. For example, the total current consumption of a USB RF keyboard regulated by USB IF should be lower than 2.5 mA in “sleep” mode (namely, Iₜₒₜₐₗ<2.5 mA). Now, by figuring out the time period T₁ and T₂ of the first and the second clock 22a/22b as 3636 ms and 200 ms, respectively, basing on the electrical parameters shown in FIG. 3, and substituting all those values into the formula of total average current:

Iₐᵥₑ=((T₁*I₂₁)+(T₂*(I₁+I₂₀+I₃)))/(T₁+T₂), thus

Iₐᵥₑ=((3636 ms*350 μA)+(200 ms*(7.5 mA+20 mA+10 mA)))/(3636 ms+200 ms)=2.287 mA<mA

We thus obtain the result

Iₐᵥₑ≦Iₜₒₜₐₗ

Also in FIG. 3, a transistor, 2N3906 or 2N3904 for example, could be adopted for the power-switching element 26 or the power-saving device 22 respectively, and further, a capacitor of 2.2 μf is suggested for the capacitor 226 of the power-saving device 22.

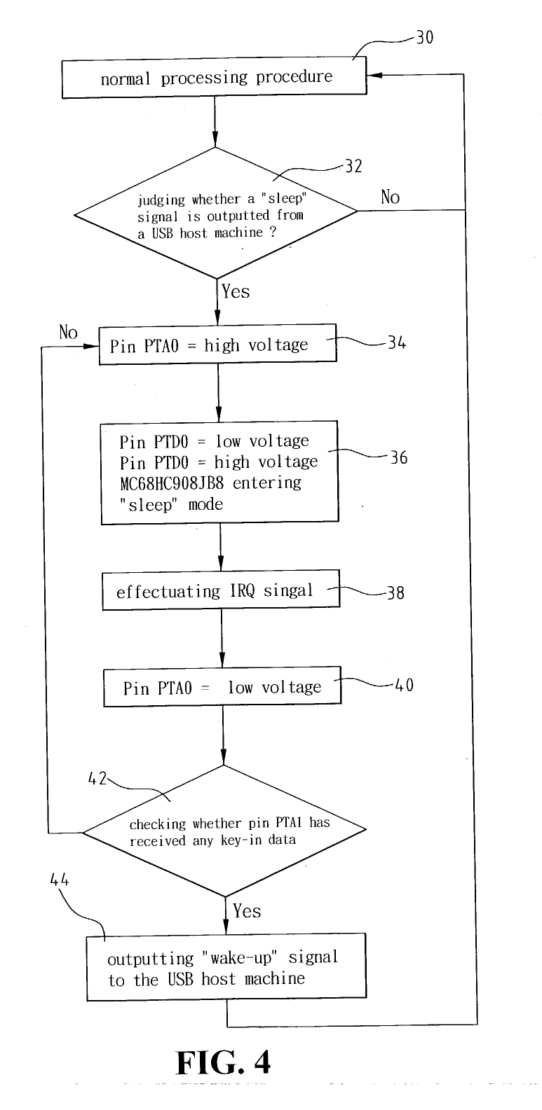

FIG. 4 shows a command-flowchart of a specific power-savable microcontroller MC68HC908JB8. The flowchart includes the following steps:

1) Step (30) is a step of normal processing procedure;

2) Step (32) is a step for judging whether a “sleep” signal is outputted from a USB host machine? Then the procedure goes to Step (34) if true, otherwise, jumps to Step (30);

3) Step (34) is a step for the microcontroller MC68HC908JB8 to output a high voltage signal from pin PAT0 to the transistor 2N3906 to cut off the power supply provided to the keyboard controller 6868C by shutting down the power-switching element 26;

4) Step (36) is a step for the microcontroller MC68HC908JB8 to output a low voltage signal from pin PTD0 to enable the capacitor 226 to discharge fast, then output a high voltage signal this time for charging the same capacitor slowly, and meanwhile, the microcontroller MC68HC908JB8 would enter the “sleep” mode;

5) Step (38) is a step to turn on the transistor 2N3904 after the capacitor 226 is slowly charged for 3636 ms (the first clock 22a) to hence effectuate an IRQ signal for the microcontroller MC68HC908JB8;

6) Step (40) is a step for the microcontroller MC68HC908JB8 to maintain “low” at pin PTA0 during IRQ procedure for 200 ms (the second clock 22b) such that the power-switching element 26 of the transistor 2N3906 can be turned on to provide power supply to the keyboard controller 6868C. At this time, the keyboard controller 6868C would scan the keys to see whether any of them is keyed and send the data thereof to pin PTA1 of the microcontroller MC68HC908JB8, if “Yes.”; and

7) Step (42) is a step for the microcontroller MC68HC908JB8 to check whether pin PTA1 has received any key-in data, and go to Step (44) to output a “wake-up” signal to the USB host machine then jump to the Step (30) if “Yes,” or jump to the Step (34), otherwise.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A method for making an electronic device having a power-non-savable processor power-savable, comprising:
(a) Providing a power-switching element for power's on/off operation of a power-non-savable processor, in accordance with the clock of a power-saving device;
(b) Turning power “off” in a cyclic time period of a first clock, or turning the power “on” in another time period of a second clock, generated by the power-saving device alternately; and
(c) Determining the cyclic time period of both the first and the second clocks, such that an average current smaller than a predetermined current can be maintained.

2. The method according to claim 1, in which said power-switching element is a transistor.

3. The method according to claim 1, in which said power-saving device comprises at least a power-savable controller, a transistor, and a capacitor.

4. A power-saving circuit for making an electronic device having a power-non-savable processor power-savable, comprising:
a power-switching element for keeping power's on/off operation of a power-non-savable processor, in accordance with the clock of a power-saving device, in which said power-saving device is in charge of releasing a cyclic signal of a first or a second clock for turning power supply of the power-non-savable processor off or on to therefore lower down the total average current of the first and the second clocks below a predetermined level.

5. The power-saving circuit according to claim 4, in which said power-switching element is a transistor.

6. The power-saving circuit according to claim 4, in which said power-saving device comprises at least a power-savable microprocessor, a transistor, and a capacitor.

7. An input device comprising the power-saving circuit according to claim 4.

8. The input device according to claim 7, which is a keyboard.

9. The input device according to claim 7, which is a mouse.

10. The input device according to claim 7, which is a USB RF keyboard.

11. The input device according to claim 7, which is a USB RF mouse.
